(19) United States
(12) Patent Application Publication
(10) Pub. No.: US 2018/0239777 A1
(43) Pub. Date: Aug. 23, 2018

(54) METHOD AND APPARATUS FOR DISSOLVING FOLDER AND MOBILE TERMINAL

(71) Applicant: BEIJING KINGSOFT INTERNET SECURITY SOFTWARE CO., LTD., BEIJING (CN)

(72) Inventor: Sini HE, BEIJING (CN)

(21) Appl. No.: 15/752,594

(22) PCT Filed: Aug. 24, 2016
(86) PCT No.: PCT/CN2016/096540

§ 371 Date: Feb. 14, 2018

(30) Foreign Application Priority Data
Aug. 27, 2015 (CN) 201510536539.3

(51) Int. Cl. G06F 17/30; G06F 3/0486; G06F 3/0481

(52) U.S. Cl. CPC G06F 17/30117; G06F 3/04817; G06F 3/0486; G06F 17/30126

(57) ABSTRACT

A method and an apparatus for dissolving a folder are provided. The method includes determining whether the folder is dragged after recognizing that the folder is selected; if yes, determining whether the folder is dragged to a position located in a preset region; and if it is determined that the folder is dragged to the position located in the preset region, displaying a content in the folder on a display interface of the mobile terminal. A mobile terminal is further provided.

### CROSS REFERENCE TO RELATED APPLICATION

This application is a U.S. national phase application based upon International Application No. PCT/CN2016/096540, filed on Aug. 24, 2016, which claims priority to and benefits of Chinese Patent Application No. 201510536539.3, filed with State Intellectual Property Office on Aug. 27, 2015, which is entitled as “Method and apparatus for de-grouping folder”, the entire content of which is incorporated herein by reference.

### FIELD

The present disclosure relates to a terminal device technology field, and more particularly to a method and an apparatus for dissolving a folder, and a mobile terminal.

### BACKGROUND

With the advent of mobile internet era, a mobile terminal becomes a significant tool in the work and life of a user gradually. The mobile terminal may include: a mobile phone, a tablet and the like. In order to bring the user more convenience, applications applicable to the mobile terminal become more and more gradually. For ease of use, icons of common used applications are displayed on a desktop of the mobile terminal. A lot of displayed icons of applications will lead to a messy desktop, and the user may use a third-party desktop application to add at least two icons of applications into a folder. The third-party desktop application is distinguished from the operating system. The third-party desktop application has richer functionalities than the original desktop application of the mobile terminal. The user may customize a display effect via the third-party desktop application. Some third-party desktop applications also provide a theme change function, providing the user a totally different visual display effect.

The existing third-party desktop application is able to aggregate icons of applications and create a folder, the user may acquire several folders by using the third-party desktop application, the name of each folder may be displayed, and the folders may be displayed on different positions on the desktop. In each folder, the applications may be displayed in a certain order.

At present, the user may use following methods to create a folder via the third-party desktop application: the user may put a finger on an icon of a first application to be put into the folder, long-pressing the icon and dragging the icon to a possible above an icon of a second application to be put into the folder, and then the folder is created and icons of the first application and the second application are displayed in the folder. Alternatively, an empty folder is created on the desktop by clicking a button named “creating a new folder”.

When other icons of applications need to be put into the folder, it is only required to put the finger on the icon of application to be put into the folder, to long-press and drag the icon in the folder.

The icon of the application may be moved out of the folder by selecting the icon of the application and dragging the icon to an edge of the folder.

In the prior art, if all icons of the applications need to be moved out from the folder A, each icon of the application in the folder should be selected and dragged to the edge of the folder. The above operation leads to a complex folder dissolving process, causing a poor user experience. In addition, in a mobile terminal, the above problem also exists when dissolving a folder storing bookmarks or pictures.

### SUMMARY

An objective of embodiments of the present disclosure is to provide a method and an apparatus for dissolving a folder.

In order to solve the above objective, embodiments of the present disclosure disclose a method for dissolving a folder. The method is applied in a mobile terminal and includes: determining whether the folder is dragged after recognizing that the folder is selected; if yes, determining whether the folder is dragged to a position located in a preset region; and if it is determined that the folder is dragged to the position located in the preset region, displaying a content in the folder on a display interface of the mobile terminal.

Embodiments of the present disclosure provide an apparatus for dissolving a folder, which is applied in a mobile terminal may include: a first judging module, configured to determine whether the folder is dragged after recognizing that the folder is selected; a second judging module, configured to determine whether the folder is dragged to a position located in a preset region if a judging result of the first judging module is positive; and a dissolving module, configured to display a content in the folder on a display interface of the mobile terminal if a judging result of the second judging module is positive.

Embodiments of the present disclosure provide a storage medium, configured to store an executable application program, the executable application program is configured to execute any of methods for dissolving a folder according to the present disclosure at running time.

Embodiments of the present disclosure provide an application program, the application program is configured to execute the method for dissolving a folder according to the present disclosure at running time.

Embodiments of the present disclosure provide a mobile terminal applicable to dissolve a folder, including: a processor, a memory, a communication interface and a bus, in which, the processor, the memory and the communication interface are connected via the bus and communicate with each other; the memory is configured to store executable program codes; the processor is configured to execute a program corresponding to the executable program codes by reading the executable program codes stored in the memory, so as to execute following steps: determining whether the folder is dragged after recognizing that the folder is selected; if yes, determining whether the folder is dragged to a position located in a preset region; and if it is determined that the folder is dragged to the position located in the preset region, displaying a content in the folder on a display interface of the mobile terminal.

### BRIEF DESCRIPTION OF THE DRAWINGS

The features and advantages of the present disclosure will be clearer through the following exemplary embodiment associated with the accompanying drawings. It should be understood that the accompanying drawings are exemplary, rather than limiting the present disclosure, in which:

FIG. 1 illustrates a process for dissolving a folder provided by an embodiment of the present disclosure;

FIG. 2A is a schematic diagram of a suspension state of a folder after the folder is selected;

FIG. 2B is a schematic diagram of a prompt message provided by an embodiment of the present disclosure;

FIG. 3 illustrates a process for dissolving a folder provided by another embodiment of the present disclosure;

FIG. 4 is a structure diagram of an apparatus for dissolving a folder provided by an embodiment of the present disclosure; and

FIG. 5 is a structure diagram of a mobile terminal provided by an embodiment of the present disclosure.

### DETAILED DESCRIPTION

In order to simplify operations for dissolving a folder and to improve efficiency of dissolving the folder and user experience, embodiments of the present invention provide a method and an apparatus for dissolving a folder.

The technical solutions in embodiments of the present invention are hereinafter described clearly and completely with reference to accompanying drawings in embodiments of the present invention. Apparently, embodiments described are a part of embodiments of the present invention, but not all embodiments. All other embodiments obtained by those skilled in the art based on the embodiments in the present invention without creative labor shall fall in the protection scope of the present invention.

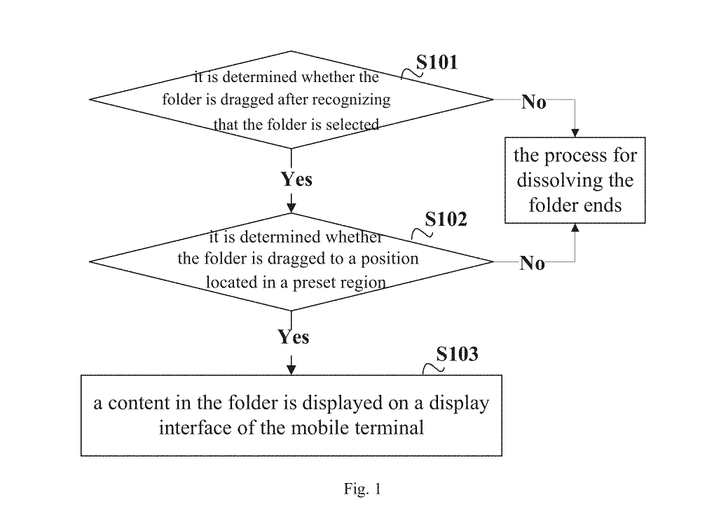

FIG. 1 illustrates a process for dissolving a folder provided by an embodiment of the present disclosure. The process is applied to a mobile terminal and the process includes followings.

At block S101, it is determined whether the folder is dragged after recognizing that the folder is selected, and if yes, an act at block S102 is performed; if no, the process for dissolving the folder ends.

The process for dissolving a folder provided by embodiments of the present disclosure is applied to a mobile terminal. The mobile terminal may be a mobile phone, a tablet and the like. It should be noted that embodiments of the present disclosure are specifically applied to the mobile terminal based on Android system.

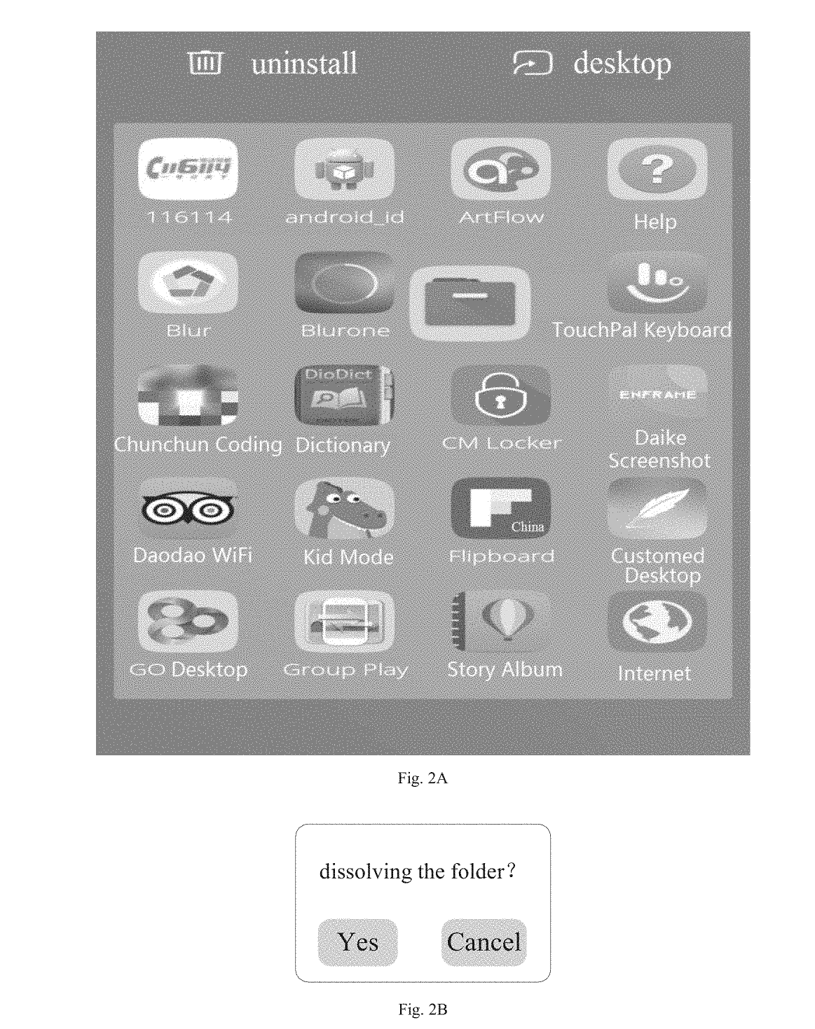

If the folder is selected, it may indicate that an icon of the folder is double-clicked. For the mobile terminal having a touch screen, it may indicate that a time period during which the icon of the folder is pressed reaches a preset time period threshold. The time period threshold may be set according to experiences or requirements. For example, the time period threshold may be 20 ms, 50 ms or 1 s and the like. When the folder is selected, for a convenience by the user of recognizing whether his or her operation is correct, a display state of the icon of the folder may be adjusted as a suspension state. FIG. 2A is a schematic diagram of a suspension state of a folder after the folder is selected. Specifically, referring to FIG. 2A, the third folder located in a second row is in the suspension state.

At block S102, it is determined whether the folder is dragged to a position located in a preset region, and if yes, an act at block S103 is performed; if no, the process for dissolving the folder ends.

In embodiments of the present disclosure, a corresponding preset region may be set for the operations for dissolving the folder. When the folder is selected and dragged to the preset region, it may be determined that the operation for dissolving a folder is performed. The preset region may be located on any region of the screen, such as an upper region, a lower region, a left region or a right region of the screen of the mobile terminal and the like. Preferably, the preset region may be set as the upper region of the screen of the mobile terminal. When the folder is selected and dragged, for a convenience of user's operations, the preset region may be displayed distinguishably, for example, it may be highlighted, or identification characters “dissolving a folder” may be displayed on the preset region, and the like, such that the user may be guided to dissolve the folder.

Determining whether the location of the dragged folder belongs to a certain region may refer to the prior art, which will not be described in embodiments of the present disclosure.

At block S103, a content in the folder is displayed on a display interface of the mobile terminal.

When the folder is selected and dragged to the preset region, it may be determined that the operation for dissolving a folder may be performed. The mobile terminal may move all contents in the folder out and display the contents on the display interface and delete the folder. The contents moved out of the folder may be displayed at any location of the display interface. The display interface may refer to an interface displayed when the application corresponding to the folder is opened. In embodiments of the present disclosure, the content in the folder may include: an icon of an application, or a bookmark, or a picture. If the content in the folder includes icons of applications, the display interface may be an interface displayed when a current desktop application is opened. If the content in the folder includes pictures, the display interface may be an interface displayed when an album application is opened. If the content in the folder includes bookmarks, the display interface may be an interface displayed when a browser application is opened.

In embodiments of the present disclosure, since the folder may be dissolved when the folder is selected and dragged to the preset region, the folder dissolving may be realized by simple operations, such that the folder dissolving process may be simplified, thereby improving efficiency of the folder dissolving and user experience.

In another embodiment of the present disclosure, in order to avoid the user's misoperation, before the content in the folder is displayed on the display interface of the mobile terminal, the method may also include: displaying a prompt message indicating whether to dissolve the folder; and performing subsequent acts when a message indicating that a user determines to dissolve the folder is received.

When the folder is selected and dragged to the preset region, it may be determined that the operation for dissolving a folder is performed, and the prompt message indicating whether to dissolve the folder may be displayed, as shown in FIG. 2B, such that the user may select whether to dissolve the folder. The user may determine to confirm or cancel the folder dissolving according to his or her requirement.

In the mobile terminal installed with desktop applications, for a convenience of using various applications, the user may put icons of the applications on the desktop. In addition, in order to satisfy user's displaying requirement, the display interface may be set as several sub-screens for displaying icons of different applications. The user may view the content displayed on each sub-screen by sliding the display interface to left or right, and may add or delete one or more sub-screens flexibly.

Preferably, in an embodiment of the present disclosure, when the content in the folder includes icons of applications, displaying the content in the folder on the display interface of the mobile terminal may include: determining whether the number of idle positions for locating icons in a sub-screen displaying the folder is greater than or equal to the number of positions occupied by icons of applications in the folder; if yes, displaying the icons of the applications in the folder on the sub-screen displaying the folder; and if no, determining whether the number of idle positions for locating icons in all sub-screens is greater than or equal to the number of positions occupied by icons of applications in the folder, if it is determined that the number of idle positions for locating icons in all sub-screens is greater than or equal to the number of positions occupied by icons of applications in the folder, distributing the icons of the applications in the folder on all the sub-screens for displaying, and if it is determined that the number of idle positions for locating icons in all sub-screens is less than the number of positions occupied by icons of applications in the folder, creating a new sub-screen and displaying the icons of the applications in the folder on the new sub-screen.

When dissolving the folder among the desktop applications, icons of applications in the folder are moved out of the folder, and the icons of the moved applications are displayed on the display interface of the mobile terminal. One icon occupies one icon-holding position. If the number of idle positions for locating icons in the sub-screen displaying the folder is greater than or equal to the number of positions occupied by icons of applications in the folder, the icons of the moved applications are displayed on the sub-screen displaying the folder; and if the number of idle positions for locating icons in the sub-screen displaying the folder is less than the number of positions occupied by icons of applications in the folder, a new sub-screen is created in the display interface, and the icons of the moved applications are displayed on the new sub-screen.

It should be understood that, if the number of idle positions for locating icons in the sub-screen displaying the folder is greater than or equal to the number of positions occupied by icons of applications in the folder, the icons of all applications in the folder may be displayed on the sub-screen displaying the folder directly, instead of displaying the icons of the applications in the folder on other existing sub-screens.

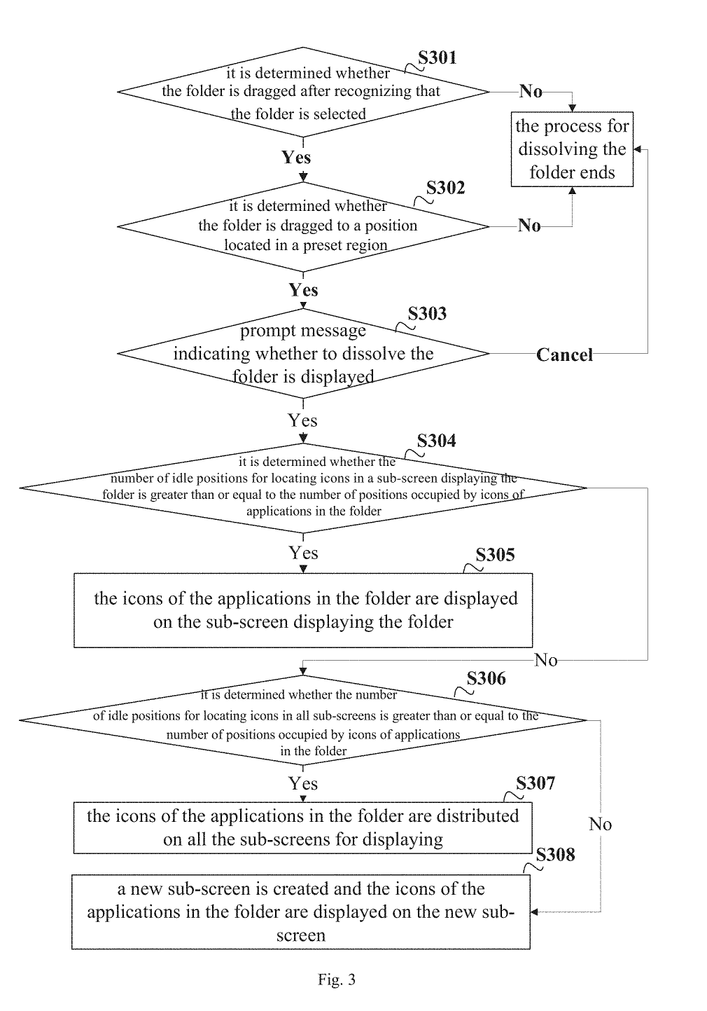

FIG. 3 illustrates a process for dissolving a folder provided by another embodiment of the present disclosure. The process may include followings.

At block S301, it is determined whether the folder is dragged after recognizing that the folder is selected, and if yes, an act at block S302 is performed; if no, the process for dissolving the folder ends.

At block S302, it is determined whether the folder is dragged to a position located in a preset region, and if yes, an act at block S303 is performed; if no, the process for dissolving the folder ends.

At block S303, a prompt message indicating whether to dissolve the folder is displayed, and when the user determines to dissolve the folder, an act at block S304 is performed; when the user cancels the folder dissolving, the process for dissolving the folder ends.

At block S304, it is determined whether the number of idle positions for locating icons in a sub-screen displaying the folder is greater than or equal to the number of positions occupied by icons of applications in the folder, and if yes, an act at block S305 is performed; if no, an act at block S306 is performed.

At block S305, the icons of the applications in the folder are displayed on the sub-screen displaying the folder.

At block S306, it is determined whether the number of idle positions for locating icons in all sub-screens is greater than or equal to the number of positions occupied by icons of applications in the folder, and if yes, an act at block S307 is performed; if no, an act at block S308 is performed.

At block S307, the icons of the applications in the folder are distributed on all the sub-screens for displaying.

At block S308, a new sub-screen is created and the icons of the applications in the folder are displayed on the new sub-screen.

In embodiments of the present disclosure, when the folder is selected and dragged to the preset region, it may be determined to dissolve the content in the folder, such that the folder dissolving may be realized by simple operations, and the folder dissolving process may be simplified, thereby improving efficiency of the folder dissolving and user experience.

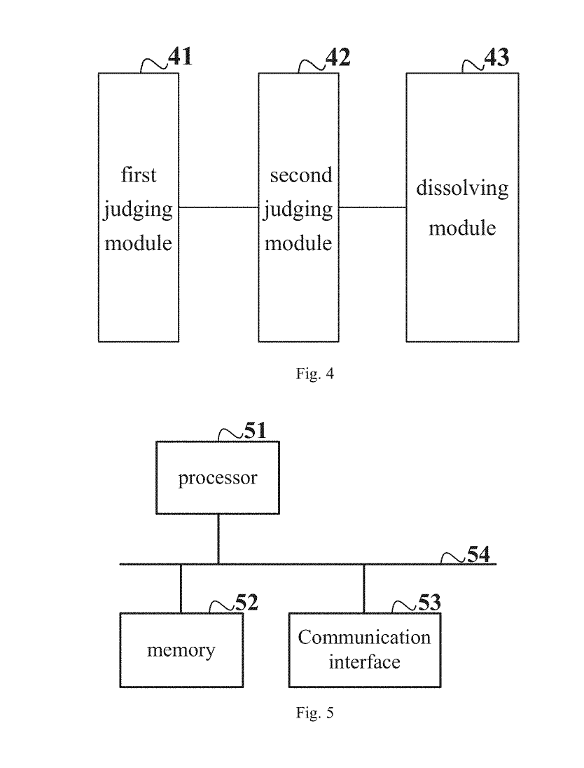

FIG. 4 is a structure diagram of an apparatus for dissolving a folder provided by an embodiment of the present disclosure, in which the apparatus is applied to a mobile terminal and includes: a first judging module 41, a second judging module 42 and a dissolving module 43.

The first judging module 41 is configured to determine whether the folder is dragged after recognizing that the folder is selected.

The second judging module 42 is configured to determine whether the folder is dragged to a position located in a preset region if a judging result of the first judging module is positive.

The dissolving module 43 is configured to display a content in the folder on a display interface of the mobile terminal if a judging result of the second judging module is positive.

The dissolving module 43 is also configured to display a prompt message indicating whether to dissolve the folder; and to display the content in the folder on the display interface when a message indicating that a user determines to dissolve the folder is received.

The first judging module 41 is also configured to recognize that the folder is selected by recognizing that a time period during which an icon of the folder is pressed reaches a preset time period threshold.

The dissolving module 43 is specifically configured to determine whether a number of idle positions for locating icons in a sub-screen displaying the folder is greater than or equal to a number of positions occupied by icons of applications in the folder; if yes, to display the icons of the applications in the folder on the sub-screen displaying the folder; and if no, to determine whether a number of idle positions for locating icons in all sub-screens is greater than or equal to the number of positions occupied by the icons of the applications in the folder, if it is determined that the number of idle positions for locating icons in all the sub-screens is greater than or equal to the number of positions occupied by the icons of the applications in the folder, to distribute the icons of the applications in the folder on all the sub-screens for displaying, and if it is determined that the number of idle positions for locating icons in all the sub-screens is less than the number of positions occupied by the icons of the applications in the folder, to create a new sub-screen and display the icons of the applications in the folder on the new sub-screen.

Embodiments of the present disclosure provide a storage medium, configured to store an executable application program, the executable application program is configured to execute the method for dissolving a folder according to any of embodiments of the present disclosure when running. The method or dissolving a folder according to an embodiment of the present disclosure may include: determining whether the folder is dragged after recognizing that the folder is selected; if yes, determining whether the folder is dragged to a position located in a preset region; and if it is determined that the folder is dragged to the position located in the preset region, displaying a content in the folder on a display interface of the mobile terminal.

In embodiments of the present disclosure, when the folder is selected and dragged to the preset region, it may be determined to dissolve the content in the folder, such that the folder dissolving may be realized by simple operations, and the folder dissolving process may be simplified, thereby improving efficiency of the folder dissolving and user experience.

Embodiments of the present disclosure provide an application program, the application program is configured to execute the method for dissolving a folder according to any of embodiments of the present disclosure when running. The method for dissolving a folder according to embodiments of the present disclosure is applied to a mobile terminal, and the method may include: determining whether the folder is dragged after recognizing that the folder is selected; if yes, determining whether the folder is dragged to a position located in a preset region; and if it is determined that the folder is dragged to the position located in the preset region, displaying a content in the folder on a display interface of the mobile terminal.

In embodiments of the present disclosure, when the folder is selected and dragged to the preset region, it may be determined to dissolve the content in the folder, such that the folder dissolving may be realized by simple operations, and the folder dissolving process may be simplified, thereby improving efficiency of the folder dissolving and user experience.

Embodiments of the present disclosure provide a mobile terminal applicable to dissolve a folder, as shown in FIG. 5, the mobile terminal may include: a processor 51, a memory 52, a communication interface 53 and a bus 54, in which, the processor 51, the memory 52 and the communication interface 53 are connected via the bus 54 and communicate with each other; the memory 52 is configured to store executable program codes; the processor 51 is configured to execute a program corresponding to the executable program codes by reading the executable program codes stored in the memory, so as to execute following steps: determining whether the folder is dragged after recognizing that the folder is selected; if yes, determining whether the folder is dragged to a position located in a preset region; and if it is determined that the folder is dragged to the position located in the preset region, displaying a content in the folder on a display interface of the mobile terminal.

In embodiments of the present disclosure, when the folder is selected and dragged to the preset region, it may be determined to dissolve the content in the folder, such that the folder dissolving may be realized by simple operations, and the folder dissolving process may be simplified, thereby improving efficiency of the folder dissolving and user experience.

Embodiments of the present disclosure provide a method and an apparatus for dissolving a folder. With the method according to embodiments of the present disclosure, when the mobile terminal recognizes that a folder is selected and dragged, it is determined whether the folder is dragged to the position located in the preset region, if yes, the content in the folder is displayed on the display interface of the mobile terminal. In embodiments of the present disclosure, when the folder is selected and dragged to the preset region, it may be determined to dissolve the content in the folder, such that the folder dissolving may be realized by simple operations, and the folder dissolving process may be simplified, thereby improving efficiency of the folder dissolving and user experience.

With respect to the system/device embodiment of the present disclosure, since the system/device corresponds to the method embodiment, the description is relatively simple, and for the relevant part, reference is made to the part of description of the method embodiment.

In should be noted that, in this description, relation terms such as first and second and the like is merely used to distinguish an object or operation from another object or operation, and it is not necessary to require or imply that there is any real relations or order among these objects or operations. Furthermore, terms “comprise”, “include” or any other modifications are aim at covering non-exclusive “include”, such that a process, a method, a term or a device including a series of elements also includes other elements which are not listed definitely. Without further limitation, an element defined by a sentence “include a . . . ” may not exclusive of other same elements included in the process, the method, the term or the device including the said element.

Each embodiment in the specification is described in the progressive manner and illustrates in emphasis what is different from the other embodiments, and the same or similar parts in the embodiments are just references to each other. With respect to the system embodiment of the present disclosure, since the system corresponds to the method embodiment, the description is relatively simple, and for the relevant part, reference is made to the part of description of the method embodiment.

The logic and/or step described in other manners herein or shown in the flow chart, for example, a particular sequence table of executable instructions for realizing the logical function, may be specifically achieved in any computer readable medium to be used by the instruction execution system, device or equipment (such as the system based on computers, the system comprising processors or other systems capable of obtaining the instruction from the instruction execution system, device and equipment and executing the instruction), or to be used in combination with the instruction execution system, device and equipment. As to the specification, “the computer readable medium” may be any device adaptive for including, storing, communicating, propagating or transferring programs to be used by or in combination with the instruction execution system, device or equipment. More specific examples of the computer readable medium comprise but are not limited to: an electronic connection (an electronic device) with one or more wires, a portable computer enclosure (a magnetic device), a random access memory (RAM), a read only memory (ROM), an erasable programmable read-only memory (EPROM or a flash memory), an optical fiber device and a portable compact disk read-only memory (CDROM). In addition, the computer readable medium may even be a paper or other appropriate medium capable of printing programs thereon, this is because, for example, the paper or other appropriate medium may be optically scanned and then edited, decrypted or processed with other appropriate methods when necessary to obtain the programs in an electric manner, and then the programs may be stored in the computer memories.

It should be understood that each part of the present disclosure may be realized by the hardware, software, firmware or their combination. In the above embodiments, a plurality of steps or methods may be realized by the software or firmware stored in the memory and executed by the appropriate instruction execution system. For example, if it is realized by the hardware, likewise in another embodiment, the steps or methods may be realized by one or a combination of the following techniques known in the art: a discrete logic circuit having a logic gate circuit for realizing a logic function of a data signal, an application-specific integrated circuit having an appropriate combination logic gate circuit, a programmable gate array (PGA), a field programmable gate array (FPGA), etc.

The present disclosure has been described with reference to the preferred embodiments, which should not be understood as limitation of the scope of the present disclosure. Various changes and modifications of the present disclosure may be made without departing from the spirit and scope of the present disclosure should be included in the scope of the present disclosure.

1. A method for dissolving a folder, applied in a mobile terminal, comprising:
determining whether the folder is dragged after recognizing that the folder is selected;
if yes, determining whether the folder is dragged to a position located in a preset region; and
if it is determined that the folder is dragged to the position located in the preset region, displaying a content in the folder on a display interface of the mobile terminal.

2. The method according to claim 1, wherein the method further comprises:
displaying a prompt message indicating whether to dissolve the folder; and
performing the step of displaying when a message indicating that a user determines to dissolve the folder is received.

3. The method according to claim 1, wherein, recognizing that the folder is selected comprises:
recognizing that a time period during which an icon of the folder is pressed reaches a preset time period threshold.

4. The method according to claim 1, wherein, the preset region is an upper region of a screen of the mobile terminal.

5. The method according to claim 1, wherein the content of the folder comprises at least one of: an icon of an application, a bookmark, and a picture.

6. The method according to claim 1, wherein, when the content of the folder is an icon of the application, displaying the content in the folder on the display interface of the mobile terminal comprises:
determining whether a number of idle positions for locating icons in a sub-screen displaying the folder is greater than or equal to a number of positions occupied by icons of applications in the folder;
if yes, displaying the icons of the applications in the folder on the sub-screen displaying the folder; and
if no, determining whether a number of idle positions for locating icons in all sub-screens is greater than or equal to the number of positions occupied by the icons of the applications in the folder, if it is determined that the number of idle positions for locating icons in all the sub-screens is greater than or equal to the number of positions occupied by the icons of the applications in the folder, distributing the icons of the applications in the folder on all the sub-screens for displaying, and if it is determined that the number of idle positions for locating icons in all the sub-screens is less than the number of positions occupied by the icons of the applications in the folder, creating a new sub-screen and displaying the icons of the applications in the folder on the new sub-screen.

7. An apparatus for dissolving a folder, applied in a mobile terminal, and comprising:
a processor;
a memory storing instructions executable by the processor;
wherein the processor is configured to:
determine whether the folder is dragged after recognizing that the folder is selected;
determine whether the folder is dragged to a position located in a preset region if the folder is dragged; and
display a content in the folder on a display interface of the mobile terminal if it is determined that the folder is dragged to the position located in the preset region.

8. The apparatus according to claim 7, wherein the processor is further configured to display a prompt message indicating whether to dissolve the folder; and to display the content in the folder on the display interface when a message indicating that a user determines to dissolve the folder is received.

9. The apparatus according to claim 7, wherein, the processor is further configured to recognize that the folder is selected by recognizing that a time period during which an icon of the folder is pressed reaches a preset time period threshold.

10. The apparatus according to claim 7, wherein the processor is further configured to determine whether a number of idle positions for locating icons in a sub-screen displaying the folder is greater than or equal to a number of positions occupied by icons of applications in the folder; if yes, to display the icons of the applications in the folder on the sub-screen displaying the folder; and if no, to determine whether a number of idle positions for locating icons in all sub-screens is greater than or equal to the number of positions occupied by the icons of the applications in the folder, if it is determined that the number of idle positions for locating icons in all the sub-screens is greater than or equal to the number of positions occupied by the icons of the applications in the folder, to distribute the icons of the applications in the folder on all the sub-screens for displaying, and if it is determined that the number of idle positions for locating icons in all the sub-screens is less than the number of positions occupied by the icons of the applications in the folder, to create a new sub-screen and display the icons of the applications in the folder on the new sub-screen.

11.-12. (canceled)

13. A mobile terminal applicable to dissolve a folder, comprising:
a processor, a memory, a communication interface and a bus, wherein,
the processor, the memory and the communication interface are connected via the bus and communicate with each other;
the memory is configured to store executable program codes;
the processor is configured to execute a program corresponding to the executable program codes by reading the executable program codes stored in the memory, so as to execute following steps:
determining whether the folder is dragged after recognizing that the folder is selected;
if yes, determining whether the folder is dragged to a position located in a preset region; and
if it is determined that the folder is dragged to the position located in the preset region, displaying a content in the folder on a display interface of the mobile terminal.

14. The method according to claim 2, wherein, when the content of the folder is an icon of the application, displaying the content in the folder on the display interface of the mobile terminal comprises:
determining whether a number of idle positions for locating icons in a sub-screen displaying the folder is greater than or equal to a number of positions occupied by icons of applications in the folder;
if yes, displaying the icons of the applications in the folder on the sub-screen displaying the folder; and
if no, determining whether a number of idle positions for locating icons in all sub-screens is greater than or equal to the number of positions occupied by the icons of the applications in the folder, if it is determined that the number of idle positions for locating icons in all the sub-screens is greater than or equal to the number of positions occupied by the icons of the applications in the folder, distributing the icons of the applications in the folder on all the sub-screens for displaying, and if it is determined that the number of idle positions for locating icons in all the sub-screens is less than the number of positions occupied by the icons of the applications in the folder, creating a new sub-screen and displaying the icons of the applications in the folder on the new sub-screen.

15. The method according to claim 3, wherein, when the content of the folder is an icon of the application, displaying the content in the folder on the display interface of the mobile terminal comprises:
determining whether a number of idle positions for locating icons in a sub-screen displaying the folder is greater than or equal to a number of positions occupied by icons of applications in the folder;
if yes, displaying the icons of the applications in the folder on the sub-screen displaying the folder; and
if no, determining whether a number of idle positions for locating icons in all sub-screens is greater than or equal to the number of positions occupied by the icons of the applications in the folder, if it is determined that the number of idle positions for locating icons in all the sub-screens is greater than or equal to the number of positions occupied by the icons of the applications in the folder, distributing the icons of the applications in the folder on all the sub-screens for displaying, and if it is determined that the number of idle positions for locating icons in all the sub-screens is less than the number of positions occupied by the icons of the applications in the folder, creating a new sub-screen and displaying the icons of the applications in the folder on the new sub-screen.

16. The method according to claim 4, wherein, when the content of the folder is an icon of the application, displaying the content in the folder on the display interface of the mobile terminal comprises:
determining whether a number of idle positions for locating icons in a sub-screen displaying the folder is greater than or equal to a number of positions occupied by icons of applications in the folder;
if yes, displaying the icons of the applications in the folder on the sub-screen displaying the folder; and
if no, determining whether a number of idle positions for locating icons in all sub-screens is greater than or equal to the number of positions occupied by the icons of the applications in the folder, if it is determined that the number of idle positions for locating icons in all the sub-screens is greater than or equal to the number of positions occupied by the icons of the applications in the folder, distributing the icons of the applications in the folder on all the sub-screens for displaying, and if it is determined that the number of idle positions for locating icons in all the sub-screens is less than the number of positions occupied by the icons of the applications in the folder, creating a new sub-screen and displaying the icons of the applications in the folder on the new sub-screen.

17. The apparatus according to claim 8, wherein the processor is further configured to determine whether a number of idle positions for locating icons in a sub-screen displaying the folder is greater than or equal to a number of positions occupied by icons of applications in the folder; if yes, to display the icons of the applications in the folder on the sub-screen displaying the folder; and if no, to determine whether a number of idle positions for locating icons in all sub-screens is greater than or equal to the number of positions occupied by the icons of the applications in the folder, if it is determined that the number of idle positions for locating icons in all the sub-screens is greater than or equal to the number of positions occupied by the icons of the applications in the folder, to distribute the icons of the applications in the folder on all the sub-screens for displaying, and if it is determined that the number of idle positions for locating icons in all the sub-screens is less than the number of positions occupied by the icons of the applications in the folder, to create a new sub-screen and display the icons of the applications in the folder on the new sub-screen.

18. The apparatus according to claim 9, wherein the processor is further configured to determine whether a number of idle positions for locating icons in a sub-screen displaying the folder is greater than or equal to a number of positions occupied by icons of applications in the folder; if yes, to display the icons of the applications in the folder on the sub-screen displaying the folder; and if no, to determine whether a number of idle positions for locating icons in all sub-screens is greater than or equal to the number of positions occupied by the icons of the applications in the folder, if it is determined that the number of idle positions for locating icons in all the sub-screens is greater than or equal to the number of positions occupied by the icons of the applications in the folder, to distribute the icons of the applications in the folder on all the sub-screens for displaying, and if it is determined that the number of idle positions for locating icons in all the sub-screens is less than the number of positions occupied by the icons of the applications in the folder, to create a new sub-screen and display the icons of the applications in the folder on the new sub-screen.

19. The mobile terminal according to claim 13, wherein the processor is further configured to perform acts of:
displaying a prompt message indicating whether to dissolve the folder; and
performing the step of displaying when a message indicating that a user determines to dissolve the folder is received.

20. The mobile terminal according to claim 13, wherein the processor is configured to recognize that the folder is selected by an act of:
recognizing that a time period during which an icon of the folder is pressed reaches a preset time period threshold.

21. The mobile terminal according to claim 13, wherein when the content of the folder is an icon of the application, the processor is configured to display the content in the folder on the display interface of the mobile terminal by acts of:
determining whether a number of idle positions for locating icons in a sub-screen displaying the folder is greater than or equal to a number of positions occupied by icons of applications in the folder;
if yes, displaying the icons of the applications in the folder on the sub-screen displaying the folder; and
if no, determining whether a number of idle positions for locating icons in all sub-screens is greater than or equal to the number of positions occupied by the icons of the applications in the folder, if it is determined that the number of idle positions for locating icons in all the sub-screens is greater than or equal to the number of positions occupied by the icons of the applications in the folder, distributing the icons of the applications in the folder on all the sub-screens for displaying, and if it is determined that the number of idle positions for locating icons in all the sub-screens is less than the number of positions occupied by the icons of the applications in the folder, creating a new sub-screen and displaying the icons of the applications in the folder on the new sub-screen.
